(19) United States
(12) Patent Application Publication
(10) Pub. No.: US 2015/0053556 A1
(43) Pub. Date: Feb. 26, 2015

(54) BIOCHIP MICRO-POROUS SENSOR

(71) Applicant: Shenzhen Createcare Medical Instrument Co.,Ltd., Shenzhen City (CN)

(72) Inventor: Bin ZHUANG, Shenzhen City (CN)

(21) Appl. No.: 14/459,864

(22) Filed: Aug. 14, 2014

(30) Foreign Application Priority Data
Aug. 23, 2013 (CN) 201310370903.4

(51) Int. Cl. G01N 15/12; G01N 27/403

(52) U.S. Cl. CPC G01N 15/1218; G01N 27/403
USPC 204/403.01

(57) ABSTRACT

An improved biochip micro-porous sensor includes a substrate, in which a micro-pore, sensing electrodes and micro-channels are disposed. At least one transition channel is disposed at one side of the micro-pore, and at least one reservoir is connected with the micro-channel. At least two sensing electrodes are disposed at left side and right side of the micro-pore, respectively. A raised object is disposed at the transition channel, descending from the micro-pore down to a bottom surface of the micro-channel, such that the micro-channels and the reservoir have a depth greater than a depth of the micro-pore.

### CROSS-REFERENCE TO RELATED APPLICATIONS

The entire contents of China Patent Application No. 201310370903.4, filed on Aug. 23, 2013, from which this application claims priority, are incorporated herein by reference.

### BACKGROUND OF THE INVENTION

1. Field of the Invention

The present invention generally relates to a microfluidic biochip, and more particularly to a biochip micro-porous sensor.

2. Description of Related Art

According to the Coulter principle, when particles suspended in an electrolyte solution pass through an orifice of a conduit, at which the electrolyte solution is replaced by the particles, resistance between two electrodes respectively disposed at two sides of the conduit will have a transient change. As a constant current is maintained between the electrodes, electric pulses may then be generated. The size and amount of the electric pulses may be proportional to the size and amount of the particles. A micro-porous sensor composing the microfluidic biochip may be made according to the Coulter principle. In order to detect cells or particles passing a micro-pore, the micro-pore should have a small cross-sectional area. Research has shown that the micro-pore should preferably have a cross-sectional area 2-20 times the cells or particles. For example, as a sperm has a diameter of 3 micrometers or a cross-sectional area of 9 square micrometers, the micro-porous sensor of a microfluidic biochip should have a cross-sectional area of 50-300 square micrometers. Some common sizes of the micro-pore are 5×10 micrometers, 10×50 micrometers and 30×100 micrometers, where the small numeral represents a depth of the micro-pore and the large numeral represents a width of the micro-pore. It is noted that the depth of the micro-pore is limited to the cross-sectional area of a cell or particle. Meanwhile, a biochip may be currently manufactured using semiconductor technique and data storage laser disk technique. Specifically, micro-channels are etched in a silica glass material and a pattern of channels will then be copied on the surface of a polymer material by a series of technique. Accordingly, almost all designers and manufacturers of the biochip adopt a single-layer structure, in which all micro-channels have the same depth, although their widths may be different. As described above that the depth of the micro-pore is limited to the cross-sectional area of a cell or particle, this limitation also bounds the depth of the micro-channels. For achieving a better quality in manufacturing and packaging, the ratio of width to depth of a micro-channel, particularly a micro-channel made of polymer, is commonly of 2-20, preferably less than 20. Therefore, the single-layer structure also bounds widths of the micro-channels in the biochip. For the foregoing reasons, current biochip micro-porous sensors have the following problems: first, as a flow rate of the micro-channel is limited to the cross-sectional area of a cell or particle, it is difficult to obtain a microfluidic biochip with high flow rate; second, in analyzing a biochip micro-porous sensor using impedance analysis method, it is difficult to optimize resistance distribution of a conductive solution in the micro-channels, therefore affecting sensitivity of the micro-porous sensor; third, there is a limit in space for accommodating functional modules in the micro-channels, for example, regarding the micro-porous sensor, its sensitivity may be increased, but nevertheless making manufacturing more difficult, by disposing electrodes nearer two sides of a micro-pore to decrease their resistances; fourth, selectivity among packaging techniques is also limited. For the foregoing reasons, a need has thus arisen to propose an improved scheme for overcoming deficiencies of the current technique.

### SUMMARY OF THE INVENTION

In view of the foregoing, it is an object of the embodiment of the present invention to provide an improved biochip micro-porous sensor for overcoming deficiencies of conventional sensors.

According to one embodiment, an improved biochip micro-porous sensor includes a substrate, in which a micro-pore, at least two sensing electrodes and a plurality of micro-channels are disposed, the micro-pore being disposed among the plurality of micro-channels. At least one transition channel is disposed at one side of the micro-pore. At least one reservoir is connected with one of the micro-channels. At least two sensing electrodes are disposed at left side and right side of the micro-pore, respectively. A raised object is disposed at the transition channel, descending from the micro-pore down to a bottom surface of the micro-channel, such that the micro-channels and the at least one reservoir have a depth greater than a depth of the micro-pore.

### BRIEF DESCRIPTION OF THE DRAWINGS

FIG. 1 shows an exploded perspective view of an improved biochip micro-porous sensor according to one embodiment of the present invention;

FIG. 2A shows a perspective view illustrated of a substrate of FIG. 1;

FIG. 2B shows another perspective view illustrated of a substrate of FIG. 1;

FIG. 3 shows a top view illustrated of a substrate of FIG. 1;

FIG. 4A to FIG. 4C show cross-sectional views of some exemplary raised objects;

FIG. 4D shows a side view facing toward the surface 902 of FIG. 4A;

FIG. 5 shows an equivalent circuit illustrated of an improved biochip micro-porous sensor according to one embodiment of the present invention;

FIG. 6A to FIG. 6C show top views illustrated of micro-channels each comprising of multiple sub-channels;

FIG. 7 shows a partial top view illustrated of a micro-channel comprising of multiple sub-channels that are parallel disposed; and

FIG. 8A to FIG. 8K show some exemplary shapes of cross section for the micro-channel in the embodiment.

### DETAILED DESCRIPTION OF THE INVENTION

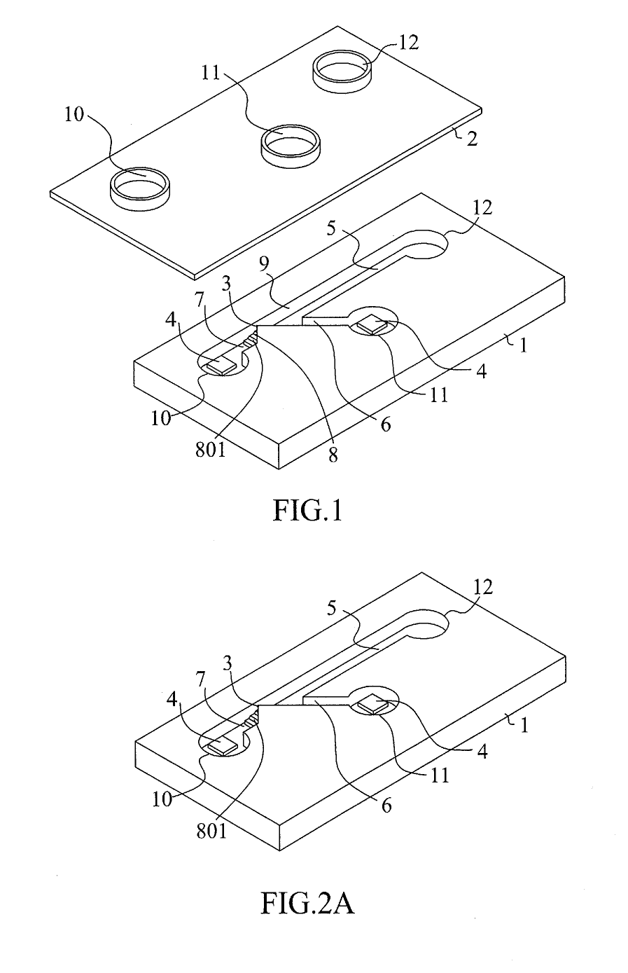

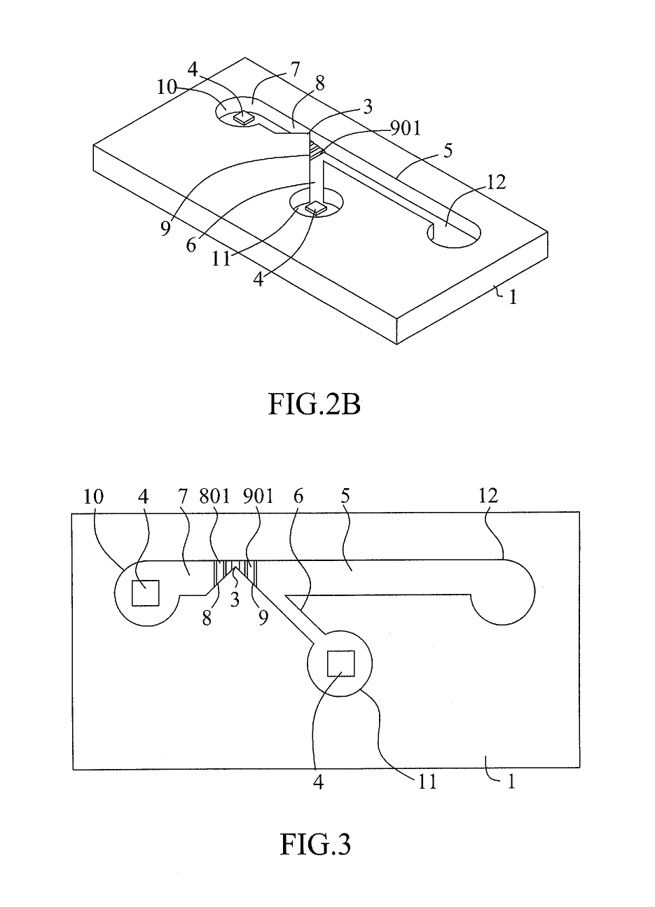

FIG. 1 shows an exploded perspective view of an improved biochip micro-porous sensor according to one embodiment of the present invention. FIG. 2A shows a perspective view illustrated of a substrate 1 of FIG. 1, and FIG. 2B shows another perspective view illustrated of a substrate 1 of FIG. 1. FIG. 3 shows a top view illustrated of a substrate 1 of FIG. 1.

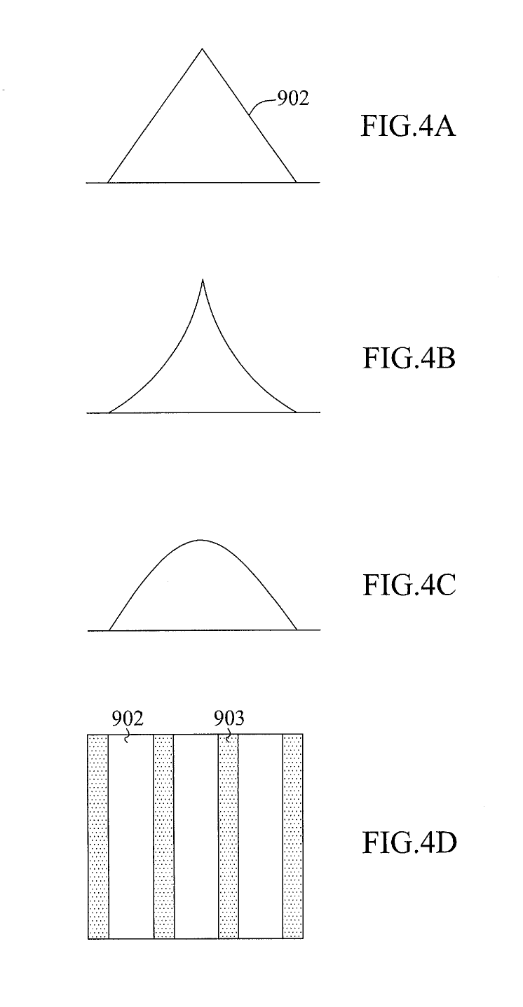

In the embodiment, the improved biochip micro-porous sensor (“sensor” hereinafter) includes a substrate 1 and a cover 2 disposed above the substrate 1. The sensor of the embodiment may be adapted for, but not limited to, detecting sperms. A micro-pore 3, two sensing electrodes 4, and some micro-channels including an analysis channel 5, a reagent channel 6 and a waste (liquid) channel 7 may be formed or disposed in the substrate 1. The micro-pore 3 is disposed among the waste channel 7, the analysis channel 5 and the reagent channel 6. A left transition channel 8 and a right transition channel 9 are disposed at left side and right side of the micro-pore 3, respectively. Specifically, the left transition channel 8 is connected with the waste channel 7, and the waste channel 7 has one side opposing the micro-pore 3 being connected with a waste (liquid) reservoir 10. The analysis channel 5 and the reagent channel 6 are connected at the right transition channel 9 of the micro-pore 3, forming an acute angle. The analysis channel 5 has one side opposing the micro-pore 3 being connected with a sample reservoir 12, and the reagent channel 6 has one side opposing the micro-pore 3 being connected with a reagent reservoir 11. Two sensing electrodes 4 are disposed at left side and right side of the micro-pore 3, respectively. According to one aspect of the embodiment, the analysis channel 5, the reagent channel 6, the waste channel 7, the sample reservoir 12, the reagent reservoir 11 and the waste reservoir 10 have a depth greater than a depth of the micro-pore 3. Further, the left transition channel 8 includes a raised object such as multiple (e.g., three) left steps 801 stepping or descending from the micro-pore 3 leftward down to a bottom surface of the waste channel 7, and the right transition channel 9 includes a raised object such as multiple (e.g., three) right steps 901 stepping or descending from the micro-pore 3 rightward down to bottom surfaces of the analysis channel 5 and the reagent channel 6. Although the left/right steps 801/901 are exemplified, it is appreciated that other modifications may be made. For example, the steps may be replaced with an inclined surface (FIG. 4A), a concave curved surface (FIG. 4B) or a convex curved surface (FIG. 4C). Moreover, a surface of the raised object may be smooth or roughened. Further, the surface 902 of the raised object may have grooves 903 as exemplified in FIG. 4D, which is a side view facing toward the surface 902 of FIG. 4A.

In the embodiment, one of the sensing electrodes 4 is disposed at the waste reservoir 10, and the other of the sensing electrodes 4 is disposed at the reagent reservoir 11.

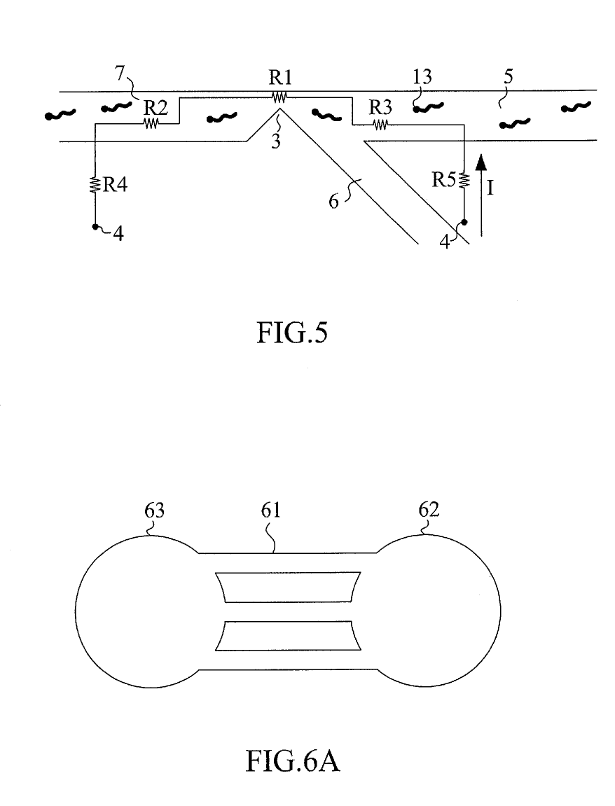

FIG. 5 shows an equivalent circuit illustrated of an improved biochip micro-porous sensor according to one embodiment of the present invention. The equivalent circuit includes series-connected resistors. Specifically, R1 designates a micro-pore resistor, R2 and R3 designate electrolyte resistors, and R4 and R5 designate electrode resistors. It is noted that a resistance of the micro-pore resistor R1 varies. For example, the micro-pore resistor R1 has a resistance A1 when no sample (such as a sperm 13) passes the micro-pore 3; and the micro-pore resistor R1 has a resistance A2 when a sperm 13 passes the micro-pore 3. The resistance A1 is inversely proportional to a cross-sectional area AS, and the resistance A2 is inversely proportional to a cross-sectional area difference between the area

AS of the micro-pore 3 and the area AC of the sperm 13. When a constant current I flows through the equivalent circuit of the sensor, the voltage V across two ends of the equivalent circuit is a product of the constant current I and a total resistance of the equivalent circuit, that is, V=Ix(R1+R2+R3+R4+R5). When no sperm passes the micro-pore 3, a voltage V1 across the two ends of the equivalent circuit is V1=Ix(A1+R2+R3+R4+R5). When a sperm 13 passes the micro-pore 3, a voltage V2 across the two ends of the equivalent circuit is V2=Ix(A2+R2+R3+R4+R5). A sensitivity of the sensor may be defined as (V2−V1)/V1, that is, a ratio of a resistance difference (between a total resistance when a sperm 13 passes and a total resistance when no sperm passes) to the total resistance when no sperm passes. The electrolyte resistor R2 and R3 and the electrode resistors R4 and R5 may be treated as constants. The smaller the constants are, the higher the sensitivity is. In the embodiment, the sensitivity of sensor may be enhanced by substantially increasing cross-sectional area of a micro-channel (e.g., the analysis channel 5, the reagent channel 6 and the waste channel 7) to reduce resistance of the electrolyte resistors, while maintaining a proper ratio of width to depth of the micro-channel. As the sensitivity is enhanced, the two sensing electrodes may therefore be disposed in the waste reservoir 4 and the reagent/ sample reservoir 11/12, respectively. As a result, difficulty in manufacturing may be substantially reduced.

According to the embodiment described above, an improved biochip micro-porous sensor includes a micro-pore disposed among a waste channel, an analysis channel and a reagent channel, and a left transition channel and a right transition channel are disposed at left side and right side of the micro-pore, respectively. The analysis channel and the reagent channel are connected at the right transition channel of the micro-pore, forming an acute angle. The embodiment is characterized that the analysis channel, the reagent channel, the waste channel, the sample reservoir, the reagent reservoir and the waste reservoir have a depth greater than a depth of the micro-pore. Further, the embodiment is characterized that the left transition channel includes multiple left steps stepping from the micro-pore leftward down to a bottom surface of the waste channel, and the right transition channel includes multiple right steps stepping from the micro-pore rightward down to bottom surfaces of the analysis channel and the reagent channel. Accordingly, a sensitivity of the sensor may be substantially enhanced, and difficulty in manufacturing may be substantially reduced.

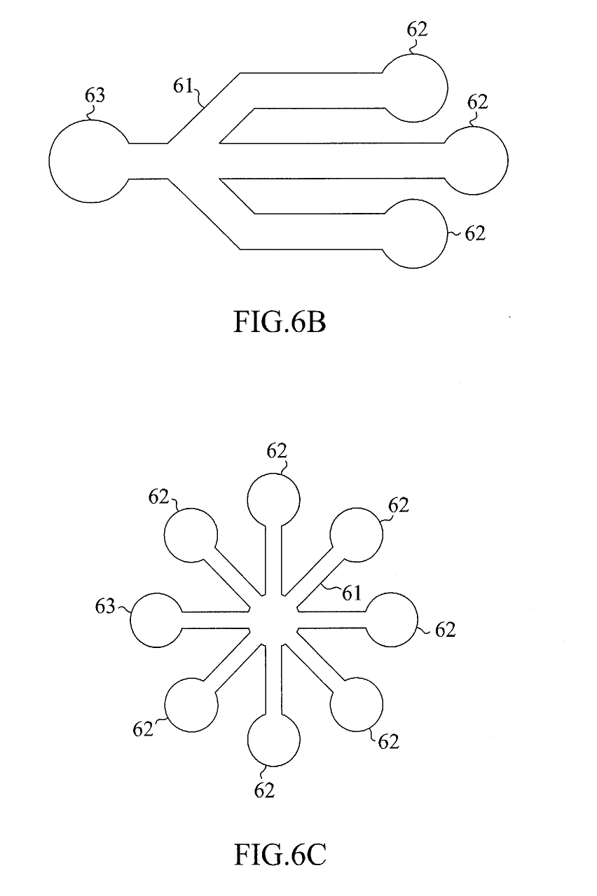

As the substrate 1 is ordinarily too thin to make fit for a multi-layer structure, a parallel structure may be adopted in the embodiment to collectively increase cross-sectional area of the micro-channel in the (single-layer) substrate 1. FIG. 6A shows a top view illustrated of a micro-channel comprising of multiple (e.g., three as shown) sub-channels 61 that are parallel disposed. First ends of the sub-channels 61 are connected to a common source (or input) reservoir 62, and second ends of the sub-channels 61 are connected to a sink (or output) reservoir 63. FIG. 6B shows a top view illustrated of a micro-channel comprising of multiple (e.g., three as shown) sub-channels 61 that are parallel disposed. First ends of the sub-channels 61 are connected to corresponding source reservoirs 62, respectively, and second ends of the sub-channels 61 are connected to a sink reservoir 63. FIG. 6C shows a top view illustrated of a micro-channel comprising of multiple (e.g., eight as shown) sub-channels 61 that are parallel disposed in a star configuration. First ends of the sub-channels 61 are connected to a common (center) node. Second ends of seven sub-channels 61 are connected to corresponding source reservoirs 62, and a second end of one sub-channel 61 is connected to a sink reservoir 63.

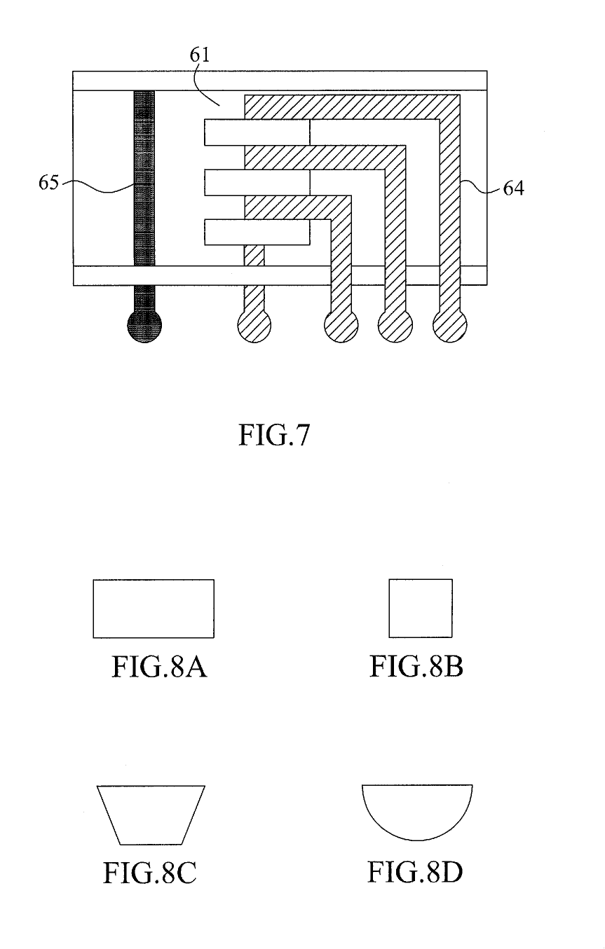

FIG. 7 shows a partial top view illustrated of a micro-channel comprising of multiple (e.g., four as shown) sub-channels 61 that are parallel disposed. Sensing electrodes 64 are disposed on each sub-channel 61, respectively, and a common sensing electrode 65 is shared among the sub-channels 61.

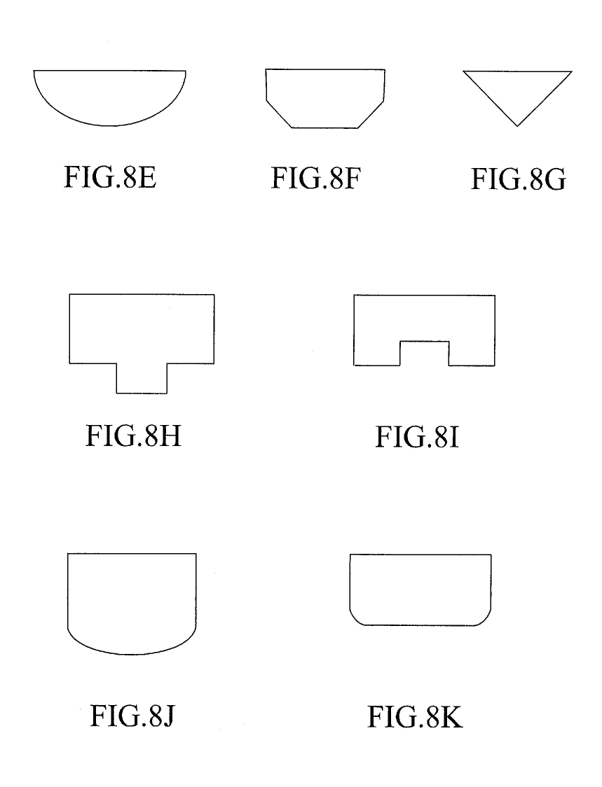

The micro-channel discussed above may have various shapes of cross section. FIG. 8A to FIG. 8K show some exemplary shapes of cross section for the micro-channel in the embodiment. One shape of the cross section shown in FIG. 8A to FIG. 8K or other shapes not shown may be selected, provided that a proper ratio of width to depth of the micro-channel is maintained, to facilitate specific applications or alleviate manufacturing difficulty.

Although specific embodiments have been illustrated and described, it will be appreciated by those skilled in the art that various modifications may be made without departing from the scope of the present invention, which is intended to be limited solely by the appended claims.

What is claimed is:

1. An improved biochip micro-porous sensor, comprising:
a substrate, in which a micro-pore, at least two sensing electrodes and a plurality of micro-channels are disposed, the micro-pore being disposed among the plurality of micro-channels;
at least one transition channel being disposed at one side of the micro-pore;
at least one reservoir each being connected with one of the micro-channels;
at least two sensing electrodes disposed at left side and right side of the micro-pore, respectively; and
a raised object disposed at the transition channel, descending from the micro-pore down to a bottom surface of the micro-channel, such that the plurality of micro-channels and the at least one reservoir have a depth greater than a depth of the micro-pore.

2. The sensor of claim 1, wherein the plurality of micro-channels comprise an analysis channel, a reagent channel and a waste channel.

3. The sensor of claim 2, wherein the at least one transition channel comprises a left transition channel and a right transition channel being disposed at left side and right side of the micro-pore, respectively.

4. The sensor of claim 3, wherein the left transition channel is connected with the waste channel,

5. The sensor of claim 3, wherein the analysis channel and the reagent channel are connected at the right transition channel, forming an acute angle between the analysis channel and the reagent channel.

6. The sensor of claim 3, wherein the at least one reservoir comprises:
a waste reservoir being connected with one side of the waste channel opposing the micro-pore;
a sample reservoir being connected with one side of the analysis channel opposing the micro-pore; and
a reagent reservoir being connected with one side of the reagent channel opposing the micro-pore.

7. The sensor of claim 6, wherein one of the at least two sensing electrodes is disposed at the waste reservoir, and another one of the sensing electrodes is disposed at the reagent reservoir.

8. The sensor of claim 1, wherein one of the plurality of micro-channels comprises a plurality of sub-channels that are parallel disposed.

9. The sensor of claim 8, wherein a sensing electrode is disposed on each said sub-channels, and a common sensing electrode is shared among the sub-channels.

10. The sensor of claim 1, further comprising a cover disposed above the substrate.

11. The sensor of claim 1, wherein the raised object comprises a plurality of steps.

12. The sensor of claim 1, wherein the raised object comprises an inclined surface, a concave surface or a convex surface.

13. The sensor of claim 1, wherein the raised object has a smooth surface or a roughened surface.

14. The sensor of claim 1, wherein the raised object has grooves.
